(19) United States
(12) Patent Application Publication
(10) Pub. No.: US 2020/0290889 A1
(43) Pub. Date: Sep. 17, 2020

(54) METHOD FOR PRODUCING VANADATE

(71) Applicant: SHOWA DENKO K.K., Tokyo (JP)

(72) Inventors: Junichi AKIYAMA, Minato-ku, Tokyo (JP); Keiichi NAKAMURA, Minato-ku, Tokyo (JP)

(73) Assignee: SHOWA DENKO K.K., Tokyo (JP)

(21) Appl. No.: 16/769,380

(22) PCT Filed: Nov. 22, 2018
(86) PCT No.: PCT/JP2018/042868

§ 371 Date: Jun. 3, 2020

(30) Foreign Application Priority Data
Dec. 4, 2017 (JP) 2017-232593
Aug. 8, 2018 (JP) 2018-149255

(51) Int. Cl. C01G 31/02; C22B 34/22; C22B 7/00

(52) U.S. Cl. CPC C01G 31/02; C22B 7/006; C22B 34/22

(57) ABSTRACT

A method for producing a vanadate extracts a vanadium component included in combustion fly ash or clinker. In the method, a vanadium component is recovered as a vanadate from combustion fly ash or clinker, the method including the following steps 1 to 5: (1) a step of adding an aqueous sodium hydroxide solution to combustion fly ash or clinker so that the water content is 5 to 35% by mass (step 1); (2) a step of mixing or kneading (step 2); (3) a step of heating the mixed or kneaded mixture (step 3); (4) a step of adding water to the mixture that has undergone the heating step in the step 3 to form a slurry (step 4); and (5) a step of recovering a vanadate in the aqueous phase after the solid-liquid separation of the slurry (step 5).

### TECHNICAL FIELD

The present invention relates to a method for producing a vanadate by extracting a vanadium component included in combustion fly ash or clinker.

### BACKGROUND ART

In boilers and the like of thermal power plants and various industrial plants, fuels such as heavy oil and petroleum coke are often used, and combustion fly ash from the exhaust gas of a combustion furnace or the clinker from the bottom of the combustion furnace is discharged. Most of these are disposed of in landfills, but the combustion fly ash contains valuable metals such as vanadium, and the effective use thereof is required from the viewpoint of preventing environmental pollution and recycling.

As a method of recovering a vanadium component from such combustion fly ash, the following methods are conventionally known.

For example, in Patent Literature 1, a large amount of water is added to combustion fly ash to convert the combustion fly ash into an aqueous slurry, and then an aqueous solution containing sodium hydroxide is added to recover vanadium. Non Patent Literature 1 states that an aqueous sodium hydroxide solution is added to boiler slag generated in a thermal power plant to recover vanadium.

### CITATION LIST

### Patent Literature

Patent Literature 1: JP-A 2013-522454

### Non Patent Literature

Non Patent Literature 1: Naganori ROKUKAWA, “Recovery of Vanadium from Boiler Slag of Oil Fired Power Plant,” Journal of the Mining and Materials Processing Institute of Japan, Vol. 107, No. 5, 295-299 (1991) <UDC 669.292.3>

### SUMMARY OF INVENTION

### Technical Problem

However, Patent Literature 1 described above has the following problem: a large amount of an aqueous sodium hydroxide solution is required and a large amount of water is included, and therefore the processing takes a long time. Non Patent Literature 1 described above has a problem in productivity because the slurry-like mixture obtained as shown in Comparative Example 1 of the present application adheres to a container or the like. Thus, it has been desired to provide a technique for quickly and economically recovering a vanadium component from combustion fly ash.

### Solution to Problem

In order to solve these problems, the present inventors have conducted intensive investigations and found that a small and specific amount of an aqueous sodium hydroxide solution is added to combustion fly ash from the exhaust gas of a combustion furnace or the clinker from the bottom of the combustion furnace, and the resultant is mixed or kneaded, and then heated to allow for vanadium to be effectively extracted as vanadate, and the present invention has been completed.

The summary of the present invention is as follows.
[1] A method for producing a vanadate, wherein a vanadium component is recovered as a vanadate from combustion fly ash or clinker, the method including the following steps 1 to 5:
(1) a step of adding an aqueous sodium hydroxide solution to combustion fly ash or clinker so that the water content is 5 to 35% cy mass (step 1);
(2) a step of mixing or kneading (step 2);
(3) a step of heating the mixed or kneaded mixture (step 3);
(4) a step of adding water to the mixture that has undergone the heating step of step 3 to form a slurry (step 4); and
(5) a step of recovering a vanadate in an aqueous phase after the solid-liquid separation of the slurry (step 5).
[2] The method for producing a vanadate according to [1], wherein the water content in the step 1 is 5 to 30% by mass.
[3] The method for producing a vanadate according to [1] or
[2], wherein a mass ratio of combustion fly ash or clinker to sodium hydroxide in the step 1 is 1: (0.03) or more and 1: (0.51) or less.
[4] The method for producing a vanadate according to [1] to [3], wherein the mass ratio of combustion fly ash or clinker to sodium hydroxide in the step 1 is 1: (0.04) or more and 1: (0.48) or less.
[5] The method for producing a vanadate according to [3] or [4], wherein a concentration of the aqueous sodium hydroxide solution in the step 1 is 20% by mass or more and 51% by mass or less.
[6] The method for producing a vanadate according to [3] to [5], wherein the concentration of the aqueous sodium hydroxide solution in the step 1 is 30% by mass or more and 48% by mass or less.
[7] The method for producing a vanadate according to [1] to [6], wherein the heating temperature in the step 3 is 70° C. to 380° C.
[8] The method for producing a vanadate according to [1] to [7], wherein the heating temperature in the step 3 is 80° C. to 120° C.
[9] The method for producing a vanadate according to [1] to [8], wherein a solid content concentration of the, slurry in the step 4 is 20% by mass or more and 30% by mass or less.
[10] The method for producing a vanadate according to [1] to [9], wherein the vanadate is sodium metavanadate.

### Advantageous Effects of Invention

The present invention can rapidly extract a vanadium component as a vanadate from combustion fly ash or clinker without requiring a large reaction vessel. In addition, adding a small amount of an aqueous sodium hydroxide solution to combustion fly ash or clinker allows for treatment as a solid powder not as a liquid slurry until arriving at a step of finally recovering a vanadium component as a liquid slurry, and usage of conventional equipment for solids such as a carrier and a storage tank in a plant having a boiler combustion furnace without a design change. The economic effect is therefore large. The produced vanadate is receiving attention in terms demand in the field of redox flow batteries.

### BRIEF DESCRIPTION OF DRAWING

FIG. 1 shows a schematic flow diagram of an example of the method for producing a vanadate according to the present invention.

### DESCRIPTION OF EMBODIMENTS

Hereinafter, embodiments of the present invention will be described.

The present invention uses combustion fly ash or clinker which is an after-burn residue discharged from the bottom of a boiler combustion furnace, particularly preferably petroleum-based combustion fly ash. A plurality of combustion fly ashes or clinkers may be used.

The petroleum-based combustion fly ash is ash recovered from exhaust gas generated in burning petroleum-based fuels such as heavy oil and petroleum coke, and the petroleum-based combustion fly ash used in the present invention further includes burnt combustion fly ash composed of a metal oxide or sulfur content obtained by further burning petroleum-based combustion fly ash.

In thermal power plants and the like, electric dust collectors and bag filters are used to remove dust from exhaust gas.

The dust recovered at this time is called “combustion fly ash.”

The vanadium component is present in the petroleum-based combustion fly ash as vanadium oxide, ammonium vanadate, sodium vanadate, or vanadium sulfate. The amount of the vanadium component included in the petroleum-based combustion fly ash varies depending on the fuel used, and is typically in the range of 0.5 to 2.5% by mass in terms of vanadium metal.

The average particle size of the petroleum-based combustion fly ash is not particularly limited, and is typically 10 to 100 μm. Combustion fly ash as aggregates or coarse particles may be classified or ground, as necessary.

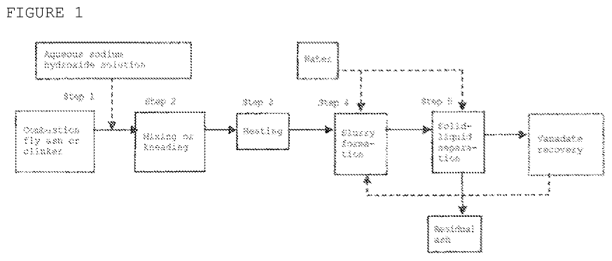

The present invention is a method for recovering a vanadium component as a vanadate from combustion fly ash or clinker, particularly preferably from petroleum-based combustion fly ash, and is a method for producing a vanadate, including the following steps 1 to 5:
(1) a step of adding an aqueous sodium hydroxide solution to combustion fly ash or clinker so that a water content is within a predetermined range (step 1);
(2) a step of mixing or kneading (step 2);
(3) a step of heating the mixed or kneaded mixture (step 3);
(4) a step of adding water to the mixture that has undergone the heating step in the step 3 to form a slurry (step 4); and
(5) a step of recovering a vanadate into an aqueous phase after solid-liquid separation of the slurry (step 5). FIG. 1 shows a flow diagram showing an example of the producing method according to the present invention.

In one embodiment of the present invention, molybdenum, aluminum, or silicon can be recovered from combustion fly ash or clinker.

### Step 1

An aqueous sodium hydroxide solution is added to combustion fly ash or clinker, preferably petroleum-based combustion fly ash.

The amount of an aqueous sodium hydroxide solution to be added is an amount to enable mixing or kneading of combustion fly ash or clinker and also to enable treatment as a solid, that is, an amount to make the water content of the entire mixture after mixing or kneading the combustion fly ash or clinker with the aqueous sodium hydroxide solution to be 5 to 35% by mass, preferably 5 to 30% by mass, more preferably 5 to 20% by mass, furthermore preferably 5 to 10% by mass, still more preferably 6 to 20% by mass, and most preferably 6 to 10% by mass.

In order to sufficiently extract the vanadium component, it is necessary that, for example, an equivalent or more, in the following reaction equation, of sodium hydroxide is included.

V₂O₅+2NaOH→2NaVO₃+H₂O

In the case of the above reaction equation, the generated vanadate is sodium metavanadate. The vanadate in the invention of the present application includes salts that generate the following vanadate ions. That is, examples of the vanadate ion include VO₄³⁻, V₂O₇⁴⁻, V₃O₉³⁻, V₄O₁₂⁴⁻, V₅O₁₄³⁻, V₁₀O₂₈⁶⁻, V₁₂O₃₂⁴⁻, V₁₃O₃₄³⁻, V₁₈O₄₂¹²⁻, [VO₃]ₙⁿ⁻ (VO₃⁻ when n is 1), and [V₃O₈]ₙⁿ⁻ (V₆O₁₆²⁻ when n is 2) (n is a natural number).

The vanadate may include a small amount of ammonium vanadate derived from an ammonium salt such as ammonium sulfate in addition to sodium vanadate such as sodium metavanadate.

Similarly, a molybdenum, aluminum, or silicon component can be extracted and recovered by adding an aqueous sodium hydroxide solution to combustion fly ash or clinker.

Examples of molybdenum to be extracted include molybdenum oxide, molybdate, molybdenum sulfide, and metallic molybdenum.

Examples of aluminum to be extracted include alumina, aluminum hydroxide, aluminate, aluminum chloride, and metallic aluminum.

Examples of silicon to be extracted include silica, sodium silicate, and metallic silicon.

An aqueous sodium hydroxide solution including sodium in an amount equivalent or more to those of vanadium, molybdenum, aluminum, and silicon, which are to be extracted, contained in combustion fly ash or clinker, and those of vanadium, molybdenum, aluminum, silicon, and the like, which are to be extracted, contained in combustion fly ash or clinker are preferably added.

The amount of sodium hydroxide to be added is preferably 1: (0.03) or more and 1: (0.51) or less, more preferably 1: (0.04) or more and 1: (0.4) or less, and particularly preferably 1: (0.05) or more and 1: (0.24) or less, in terms of mass ratio of combustion fly ash or clinker:sodium hydroxide. The concentration of the aqueous sodium hydroxide solution is 20% by mass or more and 51% by mass or less, preferably 23% by mass or more and 51% by mass or less, more preferably 40% by mass or more and 50% by mass or less, furthermore preferably 30% by mass or more and 48% by mass or less, and most preferably 40% by mass or more and 48% by mass or less.

When the aqueous sodium hydroxide solution having a predetermined concentration is added in such a range, combustion fly ash or clinker does not turn into a slurry and can be treated as solid powder.

For example, a 48% by mass aqueous sodium hydroxide solution is added at the mass ratio of combustion fly ash or clinker:aqueous sodium hydroxide solution preferably of 1:0.03 to 1:1.00, particularly preferably in the range of 1:0.125 to 1:1.00

### Step 2

The added aqueous sodium hydroxide solution and the combustion fly ash or clinker are mixed or kneaded.

In the present description, mixing refers to an operation of combining the blended raw materials to obtain a homogeneous state, and kneading refers to an operation of, in addition to distributing or dispersing the mixture to a homogeneous state, applying a shearing force, heating as necessary, and kneading. Mixing or kneading can be performed using a commonly used means.

Mixing can be performed using, for example, a tumbler.

A kneading method is not particularly limited, and it is also possible to perform kneading with hands or a mortar, and kneading machines such as batch kneaders such as kneaders, continuous kneaders, batch mixing machines such as ribbon mixers, and continuous mixing machines such as pug mixers and Loedige mixers may also be used.

In mixing or kneading, the added aqueous sodium hydroxide solution is mixed so as not to be lumps in combustion fly ash or clinker. In the present invention, the water content of the aqueous sodium hydroxide solution added in the step 1 is small, allowing for treatment as solid ash, and therefore it is unnecessary to significantly change the design of the carrier and storage tank of a plant and the vanadium component can be extracted from the burnt fly ash or clinker at low cost.

The form of the mixed or kneaded mixture may be an aggregate, a pellet, a granule, or a powder, and is not particularly limited as long as the shape can be maintained.

### Step 3

The mixed or kneaded mixture is heated. The step 3 may be performed simultaneously with the step 2.

The heating temperature may preferably be 70 to 380° C., more preferably 70 to 180° C., and furthermore preferably 80 to 120° C., and is most preferably in the range of 80 to 100° C.

The heating time is not particularly limited as long as the mixture is homogenized. The mixture is heated for about 1 to 60 minutes.

Performing the steps 2 and 3 can increase the recovery rate of vanadium in combustion fly ash or clinker without using excessive sodium hydroxide. When an excess aqueous sodium hydroxide solution is added to form a slurry without mixing or kneading under the predetermined conditions of the present invention and then vanadium is extracted by heating, the vanadium recovery rate may not become sufficiently high, and therefore mixing or kneading is preferable.

### Step 4

Water is added to the mixture that has undergone the heating step in the step 3, and the mixture is made into a slurry. The amount of water to be added is not particularly limited as long as the mixture becomes a slurry. Typically, water is added so that the solid content concentration of the slurry is 20% by mass or more and 30% by mass or less. The temperature during slurrying is not particularly limited. The stirring of the slurry can be performed by a known mixing machine such as a mixer.

### Step 5

The slurry is solid-liquid separated. The solid-liquid separation can be performed by filtration, and examples thereof include filtration means such as a filter press, a belt press, centrifugal dehydration, and a vacuum belt filter.

A vanadate, for example, sodium metavanadate, is recovered in the solid-liquid separated aqueous phase. During the solid-liquid separation, the solid content may be washed with water as necessary. The amount of vanadate to be recovered can be increased by recovering the water recovered after washing is recovered into the aqueous phase.

The aqueous solution of vanadate may be adjusted to pH 2 to 4 to precipitate vanadium oxide. This vanadium oxide is recovered, sodium carbonate and sodium chlorate are added, the liquid is adjusted to weak acidity to dissolve vanadium oxide, undissolved matter in the liquid is filtered, ammonia or ammonium salt is then added to the filtrate, and the filtrate is heated to about 75 to 85° C. to precipitate ammonium vanadate again, thereby allowing for a vanadium compound with less impurities to be recovered.

The recovered aqueous phase can be circulated as a dispersion medium (water) for slurrying in the step 4. In the case of the circulation, with monitoring the concentration, the circulated recovered liquid may be periodically discharged to the outside of the system and fresh water may be introduced.

After the solid-liquid separation, the vanadium concentration in the solid content (residual ash) produced by removing the vanadium component in the burnt fly ash is measured to calculate the vanadium extraction rate. A high level of extraction rate of 90% or more can be achieve according to the present invention.

### EXAMPLES

Hereinafter, the invention according to the present embodiment will be described more specifically with reference to Examples, but the invention according to the present embodiment is not limited only to the following Examples.

Calculation of the extraction rates of vanadium, molybdenum, aluminum, and silicon evaluated in the Examples was performed as follows.

### [Equation for Calculating Each Extraction Rate in the 5th Step]

Vanadium extraction rate (%)={(mass of vanadium in combustion fly ash before extraction−mass of vanadium in residual ash after extraction)/mass of vanadium in combustion fly ash before extraction}×100

Molybdenum extraction rate (%)={(mass of molybdenum in combustion fiy ash before extraction−mass of molybdenum in residual ash after extraction)/mass of molybdenum in combustion fly ash before extraction}×100

Aluminum extraction rate (%)={(mass of aluminum in combustion fly ash before extraction−mass of aluminum in residual ash after extraction)/mass of aluminum in combustion fly ash before extraction}×100

Silicon extraction rate (%) {(mass of silicon in combustion fly ash before extraction−mass of silicon in residual ash after extraction)/mass of silicon in combustion fly ash before extraction}×100

The quantification of vanadium, molybdenum, aluminum, and silicon was performed by the following method.

Acid decomposition: 0.1 g of a sample, 6 mL of phosphoric acid (manufactured by Junsei Chemical Co., Ltd., special grade), 4 mL of hydrochloric acid (manufactured by Junsei Chemical Co., Ltd., special grade), 2.5 mL of hydrofluoric acid (manufactured by Junsei Chemical Co., Ltd., 46% to 48% of special grade), and 2 mL of nitric acid (manufactured by Kanto Chemical Co., Inc., nitric acid for electronics industry, 1.42EL) are placed in a microwave decomposition container MWS3+, manufactured by Actak K.K.).

Microwave thermal decomposition was performed under the following conditions.

Raising to 190° C. in 5 minutes and maintaining 190° C. for 5 minutes.

Raising to 210° C. in 2 minutes and maintaining 210° C. for 5 minutes.

Raising to 230° C. in 2 minutes and maintaining 230° C. for 25 minutes.

Lowering to 100° C. in 1 minute and coming to an end.

Repeating the series of the above decomposition operation twice.

The whole amount of the acid decomposition solution was transferred to a 250 mL volumetric flask, diluted up to 250 with ultrapure water (Direct-Q UV, manufactured by Merck KGaA) to take 10 mL from the diluted 250 mL, and the sample further diluted up to 100 mL was used as as analysis sample. In accordance with JIS K0116-2014, the analysis sample was measured by ICP-AES (ICES-8100, manufactured by Shimadzu Corporation), and vanadium, molybdenum, aluminum, and silicon were quantified.

### [XRD Measurement]

Measurement was performed using SmartLab SE, manufactured by Rigaku Corporation.

### Example 1

Combustion fly ash was recovered by a petroleum coke (also called oil coke) combustion boiler electric dust collector. In this combustion fly ash, the vanadium concentration was 1.33% by mass in terms of metallic vanadium, the molybdenum concentration was 0.012% by mass in terms of metallic molybdenum, the aluminum concentration was 1.84% by mass in terms of metallic aluminum, and the silicon concentration was 3.2% by mass in terms of silicon element. A 48% by mass aqueous sodium hydroxide solution was added to this combustion fly ash so as to have a mass ratio shown in Table 1. The water content at this time is as shown in Table 1. The combustion fly ash to which the aqueous sodium hydroxide solution was added was put in a polyethylene bag, kneaded well with hands at room temperature (23° C.), and then put in a constant temperature bath at 80° C. After 1 hour, pure water was added to the combustion fly ash that had been taken so that the solid content concentration of the slurry became 20% by mass, and the operation of stirring and extracting was performed with a magnetic stirrer for 15 minutes. The solution was suction-filtered with a Kiriyama funnel (filter paper: No. 5C), and the residue was washed with pure water 1.6 times by mass of the combustion fly ash. The residue was dried in a dryer at 110° C. for 2 hours, and decomposed in a microwave, and the above metal components were measured. Table 1 shows the results of the vanadium extraction rate, and Table 2 shows the results of the molybdenum, aluminum, and silicon extraction rates.

The method of mixing the combustion fly ash and the 48% by mass aqueous sodium hydroxide solution at this time is changed to a method of mixing by using a pestle in a mortar or changed to a method of kneading with a twin screw kneader, providing similar results.

The vanadium concentration in the combustion fly ash was 1.33% by mass, and therefore the amount of the 48% by mass aqueous sodium hydroxide solution required for the reaction of the reaction equation described in the description of the step 1 is calculated as 0.0217 g per g of combustion fly ash. In the present invention, as shown in the present Example, it is preferable to add an aqueous sodium hydroxide solution including an amount of sodium equivalent or more to that of vanadium, which is to be extracted, contained in combustion fly ash or clinker.

TABLE 1

| Mass ratio | | | |
|---|---|---|---|
| | 48% by mass | Water content after | Vanadium |
| Combus- | aqueous | addition of 48% by | extrac- |
| tion | sodium | mass aqueous sodium | tion |
| f1y | hydroxide | hydroxide solution | rate |
| ash | solution | (% by mass) | (%) |
| 1 | 0.0125 | 0.6 | 50 |
| 1 | 0.125 | 5.8 | 92 |
| 1 | 0.170 | 7.6 | 95 |
| 1 | 0.250 | 10.4 | 98 |
| 1 | 0.500 | 17.3 | 98 |
| 1 | 0.700 | 21.4 | 98 |

TABLE 2

| Mass ratio | | | | |
|---|---|---|---|---|
| | 48% by mass | Water content after | | Elements |
| Combus- | aqueous | addition of 48% by | | extrac- |
| tion | sodium | mass aqueous sodium | | tion |
| fly | hydroxide | hydroxide solution | Extracted | rate |
| ash | solution | (% by mass) | elements | (%) |
| 1 | 0.125 | 5.8 | Mo | 75 |
| | | | Al | 21 |
| | | | Si | 23 |

### Example 2

In Example 1, the sodium hydroxide concentration of the aqueous sodium hydroxide solution used was 32% by mass, the ratio of combustion fly ash:aqueous sodium hydroxide solution was a mass ratio of 1:0.171, and the extraction operation was performed in the same manner. The results are shown in Table 3.

TABLE 3

| Mass ratio | | | |
|---|---|---|---|
| | 32% by mass | Water content after | Vanadium |
| Combus- | aqueous | addition of 32% by | extrac- |
| tion | sodium | mass aqueous sodium | tion |
| fly | hydroxide | hydroxide solution | rate |
| ash | solution | (% by mass) | (%) |
| 1 | 0.171 | 9.9 | 91 |

### Example 3

In Example 1, the sodium hydroxide concentration of the aqueous sodium hydroxide solution used was 50% by mass, the temperature of a constant temperature bath and the amount of the aqueous sodium hydroxide solution to be added were set to the conditions shown in Table 3, and the extraction operation was performed in the same manner.

Table 4 shows the results of the vanadium extraction rate.

TABLE 4

| Mass ratio | | | | |
|---|---|---|---|---|
| | 50% by mass aqueous | Water content after addition | | |
| Combustion | sodium hydroxide | of 50% by mass aqueous sodium | Temperature of a constant | Vanadium extraction |
| fly ash | solution | hydroxide solution (% by mass) | temperature bath (° C.) | rate (%) |
| 1 | 0.125 | 5.6 | 25 | 48 |
| 1 | 0.125 | 5.6 | 40 | 50 |
| 1 | 0.125 | 5.6 | 60 | 54 |
| 1 | 0.125 | 5.6 | 80 | 92 |

### Example 4

In Example 1, the combustion fly ash to which the aqueous sodium hydroxide solution had been added under the conditions shown in Tables 5 and 6 was put into a kneader (Kneader PNV-5H, manufactured by Irie Shokai Co., Ltd.), and was kneaded at room temperature (23° C.) for 60 minutes, the mixture of the combustion fly ash and the aqueous sodium hydroxide solution was taken out from the kneader, the temperature of the kneader was set to the conditions shown in Tables 5 and 6, and the mixture was put into the kneader to be kneaded for 60 minutes. Pure water was added to the combustion fly ash that had been taken so that the solid content concentration of the slurry became 20% by mass, and the operation of stirring and extracting was performed with a magnetic stirrer for 15 minutes. The solution was suction-filtered with a Kiriyama funnel (filter paper: No. 5B), and the residue was washed with pure water 1.6 times by mass of the combustion fly ash. The residue was dried in a dryer at 110° C. for 2 hours, and decomposed in a microwave, and the metal measurement was performed. Tables 5 and 6 show the results of the vanadium extraction rate.

TABLE 5

| Mass ratio | | Water content | | |
|---|---|---|---|---|
| | 48% by mass | after addition | | Vanadium |
| Combus- | aqueous | of 48% by mass | Kneader | extrac- |
| tion | sodium | aqueous sodium | temper- | tion |
| fly | hydroxide | hydroxide solution | ature | rate |
| ash | solution | (% by mass) | (° C.) | (%) |
| 1 | 0.133 | 6.1 | 7.0 | 8.5 |
| 1 | 0.133 | 6.1 | 9.0 | 8.6 |
| 1 | 0.133 | 6.1 | 13.0 | 8.9 |
| 1 | 0.133 | 6.1 | 15.0 | 92 |
| 1 | 0.133 | 6.1 | 180 | 92 |

TABLE 6

| Mass ratio | | Water content | | |
|---|---|---|---|---|
| | 25% by mass | after addition | | Vanadium |
| Combus- | aqueous | of 25% by mass | Kneader | extrac- |
| tion | sodium | aqueous sodium | temper- | tion |
| fly | hydroxide | hydroxide solution | ature | rate |
| ash | solution | (% by mass) | (° C.) | (%) |
| 1 | 0.255 | 15.2 | 90 | 85 |
| 1 | 0.255 | 15.2 | 13.0 | 86 |

### Example 5

The extract (pH=13) obtained by performing the same operation as in Example 1 was neutralized with sulfuric acid, and then the neutralized solution was subjected to XRD measurement and sodium metavanadate was detected.

### Comparative Example 1

Referring to “Recovery of Vanadium from Boiler Slag of Oil Fired Power Plant,” Journal of the Mining and Materials Processing Institute of Japan, Vol. 107, No. 5 (1991) (Non Patent Literature 1 described above), combustion fly ash was mixed with a 50% by mass aqueous sodium hydroxide solution so as to have a mass ratio shown in Table 6, and an extraction operation was performed. Table 6 shows the results of the vanadium extraction rate. When the combustion fly ash and the 50% by mass aqueous sodium hydroxide solution were mixed at this mixing ratio, the mixture became slurry and the operation of mixing or kneading in powder form failed to be performed, and therefore the operation of stirring the mixture at 80° C. was performed. Thereafter, pure water was added so that the solid content concentration of the slurry became 20% by mass, and the operation of stirring and extracting was performed for 15 minutes. The mixture obtained by mixing the combustion fly ash and the 50% by mass aqueous sodium hydroxide solution at this mixing ratio adhered to a container or the like, and discharging was difficult.

TABLE 7

| Mass ratio | | | |
|---|---|---|---|
| | 50% by mass | Water content after | Vanadium |
| Combus- | aqueous | addition of 50% by | extrac- |
| tion | sodium | mass aqueous sodium, | tion |
| fly | hydroxide | hydroxide solution | rate |
| ash | solution | (% by mass) | (%) |
| 1 | 3 | 37.5 | 50 |
| 1 | 9 | 45 | 90 |

1. A method for producing a vanadate, wherein a vanadium component is recovered as a vanadate from combustion fly ash or clinker, the method comprising the following steps 1 to 5:
(1) a step of adding an aqueous sodium hydroxide solution to combustion fly ash or clinker so that a water content is 5 to 35% by mass (step 1);
(2) a step of mixing or kneading (step 2);
(3) a step of heating a mixed or kneaded mixture (step 3);
(4) a step of adding water to the mixture that has undergone the heating step in the step 3 to form a slurry (step 4); and
(5) a step of recovering a vanadate in an aqueous phase after solid-liquid separation of the slurry (step 5).

2. The method for producing a vanadate according to claim 1, wherein the water content in the step 1 is 5 to 30% by mass.

3. The method for producing a vanadate according to claim 1, wherein a mass ratio of combustion fly ash or clinker to sodium hydroxide in the step 1 is 1: (0.03) or more and 1: (0.51) or less.

4. The method for producing a vanadate according to claim 1, wherein the mass ratio of combustion fly ash or clinker to sodium hydroxide in the step 1 is 1: (0.04) or more and 1: (0.48) or less.

5. The method for producing a vanadate according to claim 3, wherein a concentration of the aqueous sodium hydroxide solution in the step 1 is 20% by mass or more and 51% by mass or less.

6. The method for producing a vanadate according to claim 3, wherein the concentration of the aqueous sodium hydroxide solution in the step 1 is 30% by mass or more and 48% by mass or less.

7. The method for producing a vanadate according to claim 1, wherein a heating temperature in the step 3 is 70° C. to 380° C.

8. The method for producing a vanadate according to claim 1, wherein the heating temperature in the step 3 is 80° C. to 120° C.

9. The method for producing a vanadate according to claim 1, wherein a solid content concentration of the slurry in the step 4 is 20% by mass or more and 30% by mass or less.

10. The method for producing a vanadate according to claim 1, wherein the vanadate is sodium metavanadate.

11. The method for producing a vanadate according to claim 2, wherein a mass ratio of combustion fly ash or clinker to sodium hydroxide in the step 1 is 1: (0.03) or more and 1: (0.51) or less.
